(19) United States
(12) Patent Application Publication
(10) Pub. No.: US 2026/0316276 A1
(43) Pub. Date: Oct. 15, 2026

(54) Sim-to-Real Reinforcement Learning for Vision-Based Dexterous Manipulation on Humanoids

(71) Applicant: NVIDIA Corp., Santa Clara, CA (US)

(72) Inventors: Toru Lin, Albany, CA (US); Kartik Sachdev, Munich (DE); Linxi Fan, Santa Clara, CA (US); Yuke Zhu, Austin, TX (US)

(73) Assignee: NVIDIA Corp., Santa Clara, CA (US)

(21) Appl. No.: 19/567,726

(22) Filed: Mar. 16, 2026

Related U.S. Application Data
(60) Provisional application No. 63/786,766, filed on Apr. 10, 2025.

(51) Int. Cl. B25J 9/16; G06N 3/092

(52) U.S. Cl. CPC B25J 9/1671; B25J 9/163; G06N 3/092; B25J 9/1612

(57) ABSTRACT

Mechanisms for configuring a humanoid robot comprising a plurality of multi-fingered graspers to perform dexterous manipulation tasks, whereby a plurality of simulated environments are generated representing a distribution of kinematic parameter combinations corresponding to a physical robot. In each simulated environment, a target trajectory sequence recorded from the physical robot is executed. For each simulated environment, a tracking error relative to execution of the target trajectory sequence by the physical robot is calculated. One or more simulated environments are selected based on a minimization of an average squared difference between simulated tracking error and real-world tracking error, and a manipulation policy for the physical robot is then trained within the selected simulated environments using reinforcement learning.

### CROSS-REFERENCE TO RELATED APPLICATIONS

This application claims priority and benefit under 35 USC 119 (e) to U.S. application Ser. No. 63/786,766, filed on Apr. 10, 2025, the contents of which are incorporated herein by reference in their entirety.

### BACKGROUND

The first challenge in applying reinforcement learning to dexterous manipulation lies in the difficulty (or impossibility) to match a simulated environment with the physical environment. While real-world reinforcement learning circumvents this problem, working with physical hardware directly is demanding in terms of hardware quality, maintenance support, and low-level controller quality or safety guarantees. With a system as high-dimensional as a humanoid robot with multi-fingered manipulator, real-world exploration becomes even more untractable. Since simulator offers unlimited chances of trial-and-error, it is natural to favor sim-to-real reinforcement learning approaches.

While reward function is commonly used as a general interface for specifying a task to train reinforcement learning policies, it is notoriously hard to design generalizable rewards for manipulation tasks, especially those that are contact-rich and/or long-horizon.

A well-defined reward function does not guarantee the successful learning of reinforcement learning policies, due to the sample complexity and reward sparsity of exploring in a high-dimensional space. The variety and complexity of contact patterns in dexterous manipulation with multi-fingered hands exacerbates this problem.

Object perception is particularly important to dexterous manipulation because the task is inevitably coupled with interaction with objects. Object perception for dexterous manipulation tasks is a longstanding challenge because the variety of objects that may be encountered is uncountable in terms of shapes, sizes, masses, colors, textures, and many other properties. Object representations that more expressive and information-dense may improve dexterity and capability of a learned policy, they also comprise a larger simulation-to-real gap.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a robot configuration system in one embodiment.

FIG. 2 depicts a process for configuring a particular humanoid robot to carry out a manipulation process.

FIG. 3 depicts an real-to-simulation tuner in one embodiment.

FIG. 4 depicts an embodiment of a process to calibrate a real-to-simulation tuner to a particular physical environment.

FIG. 5 depicts a process for determining reward functions for robotic learning of manipulation tasks.

FIG. 6 depicts a parallel processing unit in accordance with one embodiment.

FIG. 7 depicts a general processing cluster in accordance with one embodiment.

FIG. 8 depicts a memory partition unit in accordance with one embodiment.

FIG. 9 depicts a streaming multiprocessor in accordance with one embodiment.

FIG. 10 depicts a processing system in accordance with one embodiment.

FIG. 11 depicts an exemplary processing system in accordance with another embodiment.

### DETAILED DESCRIPTION

Disclosed herein are mechanisms to train a humanoid robot comprising a plurality of multi-fingered graspers to perform a range of contact-rich dexterous manipulation tasks on various objects. These tasks may include bimanual grasping, lifting, and handover. Robots trained using the disclosed mechanisms may adapt to handling a variety of real-world objects that with a variety of different physical properties (e.g. shape, size, color, material, mass), and remain robust against force disturbances.

The disclosed mechanisms comprise automated real-to-simulation tuners, a generalized reward mechanism that simplifies reward engineering for long-horizon contact-rich tasks, a divide-and-conquer distillation process that improves the sample efficiency of hard exploration problems, and a mixture of sparse and dense object representations to bridge the simulation-to-real perception gap.

The automated real-to-simulation tuner first generates a set of simulated environments that cover a large distribution of potential real-world kinematics, then executes a target trajectory sequence (pre-recorded from a physical robot) and calculates the average tracking error in each simulated environment. The real-to-simulation tuner compares the calculated tracking errors with the real-world setup's tracking error. Environments with the lowest average squared differences in tracking error are used for subsequent policy training.

The generalized reward mechanism separates rewards into “contact goals” and “object goals”. Contact goals may be specified using a keypoint-based system. Applying these reward mechanisms, long-horizon and contact-rich tasks such as bimanual handover may be learned with tabula rasa reinforcement learning.

Tasks may be initialized with settings obtained from human execution of the tasks. Difficult exploration problems may be decomposed into sub-task of reduced dimensionality. Expert policies may be trained on the sub-tasks that are distilled into a generalist policy for the full task.

The disclosed mechanisms utilize a mixture of low-dimensional and high-dimensional object representations, with modality-specific data augmentation on the high-dimensional features to reduce simulation-to-real perceptual gap.

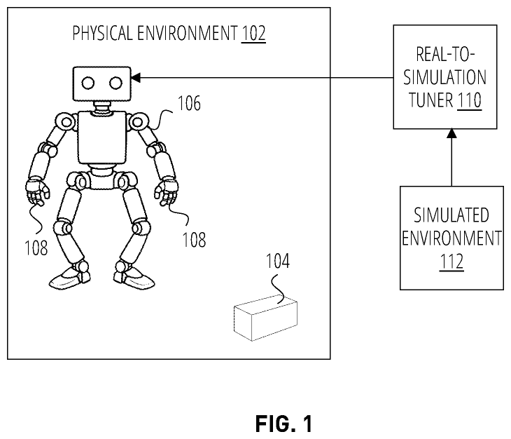

FIG. 1 depicts a robot configuration system in one embodiment. The system comprises a physical environment 102 occupied by at least one physical object 104 and a humanoid robot 106 comprising one or more multi-fingered manipulators 108. A real-to-simulation tuner 110 determines and transfers configuration settings from a simulated environment 112 to the humanoid robot 106 to enable the humanoid robot 106 to perform manipulation tasks on the one or more physical objects 104.

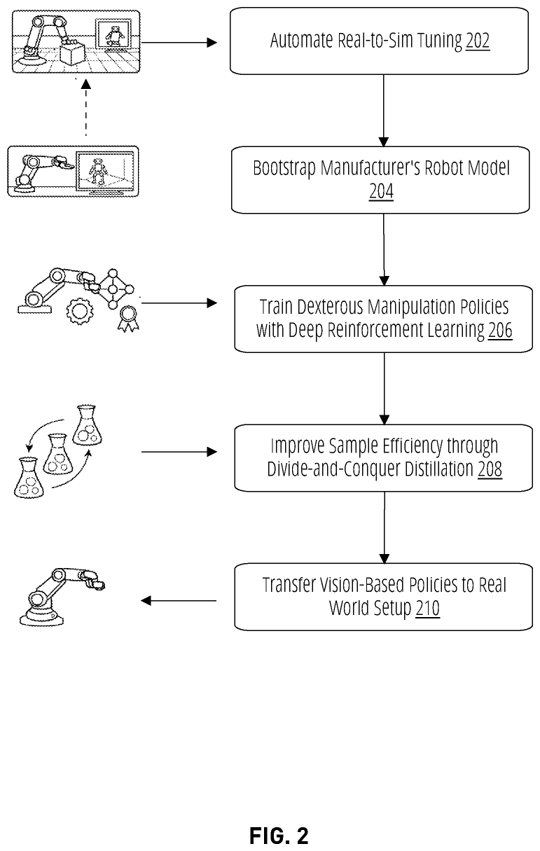

FIG. 2 depicts a process for configuring a particular humanoid robot to carry out a manipulation process. During an initial calibration process, the simulated environment 112 is matched to the physical environment 102 by the real-to-simulation tuner 110 (block 202), based on the particular humanoid robot that is deployed (block 204). Generalizable task rewards are applied to train dexterous manipulation policies in simulation with deep reinforcement learning (block 206).

Sample efficiency is improved through a divide-and-conquer distillation process (block 208). Divide-and-conquer distillation of the state space helps address the problem of exploration difficulty in sparse reward scenarios. For example, a multi-object manipulation task may be divided into multiple single-object manipulation tasks. After dividing a complex task into easier sub-tasks, specialized policies may be trained for each sub-task and then distilled into a generalist policy. An additional benefit of this approach is that it enables the flexibly filtering out of trajectory data from the sub-task policies based on their optimality, retaining only higher-quality samples for training. This effectively brings reinforcement learning closer to learning from demonstrations, where the sub-task policies act as teleoperators for task data collection in the simulation environment, and the generalist policy acts as a centralized model trained from curated data.

The resulting vision-based policies are transferred to the physical environment 102 (e.g., to the robot's control logic) with a mixture of sparse and dense object representations (block 210).

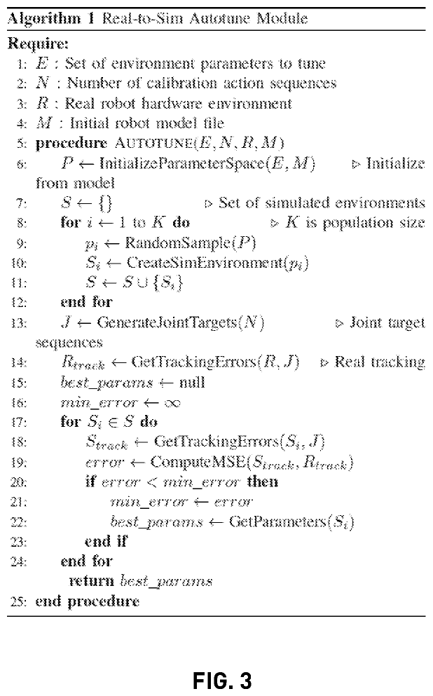

FIG. 3 depicts an real-to-simulation tuner in one embodiment. The real-to-simulation tuner calibrates simulated environment parameters such that simulated motion matches the physical robot model.

The real-to-simulation tuner enables rapid calibration of simulator parameters to match real robot behavior by automatically searching the parameter space to identify optimal values for both simulator physics and robot model. The real-to-simulation tuner operates on two parameter types: simulator physics parameters affecting kinematics and dynamics, as well as robot model constants from a URDF or similar file (including link inertia values, joint limits, and joint/link poses).

A URDF (Unified Robot Description Format) is commonly used in the Robot Operating System (ROS) ecosystem to describe the physical structure and kinematics of a robot. Among other things, the URDF or like file includes configuration settings for rigid bodies of the robot (links), such as the robot's base, arms, grippers, wheels, fingers, etc. Each link may be characterized by its geometry (visual and collision), inertial properties, (mass, center of mass, inertia tensor), and joints (how links connect and move relative to each other).

Input E comprises the list of simulator/model parameters to adjust (e.g., joint friction, motor gains, link masses, damping). Input N controls how many calibration sequences (test motions) will be used to evaluate how well each simulation matches reality. Input R is the physical robot (or a wrapper interface to it) for running calibration trajectories and measuring behavior. Input M is the baseline robot model (e.g., URDF+parameter file) used as the starting point/prior for simulation setup.

Procedure AUTOTUNE (E,N,R,M) defines the function that inputs (E, N, R, M) and outputs tuned parameters.

P←InitializeParameterSpace(E,M) builds the parameter search space P from the baseline model M, restricted to the parameters listed in E. For example, this line may set ranges around model defaults (±10% mass, friction bounds, etc.).

S←{ } initializes an empty set/list S that will hold multiple simulator instances, each with different parameter samples.

for i←1 to K do−K is population size; loops K times to create K candidate simulated environments (a population).

p_i←RandomSample(P) randomly sample one parameter set p_i from the parameter space P (one candidate “guess” of the real robot's parameters).

S_i←CreateSimEnvironment(p_i) creates a simulator environment instance S_i configured with parameters p_i.

S←S∪{S_i} adds that simulator instance to the set of candidates S.

J←GenerateJointTargets(N) creates N calibration sequences J comprising joint position targets (the motion scripts to run on real and simulated robots).

R_track←GetTrackingErrors(R, J) executes the joint target sequences J on the real robot R and records tracking errors (e.g., difference between commanded joint positions and measured positions over time). This becomes the ground truth behavior the simulations should match.

best_params←null initializes the “best found parameters” as none.

min_error←∞ initializes the best score as infinity so any real computed error will be smaller.

for S_i∈S do loops over each candidate simulated environment.

S_track←GetTrackingErrors(S_i, J) runs the same joint target sequences J in simulation S_i and compute the simulated tracking errors in the same format as R track.

error←ComputeMSE(S_track, R_track) compares simulated vs. real tracking errors using mean squared error (MSE). A lower MSE means that the simulator with parameters p_i behaves more like the real robot.

if error<min_error then if this candidate is the best so far . . . min_error←error update the best score to this smaller error.

best_params←GetParameters(S_i) stores the parameter set associated with simulator S i as the current best match.

return best_params returns the parameter set that produced the simulated behavior closest to the real robot on the calibration sequences.

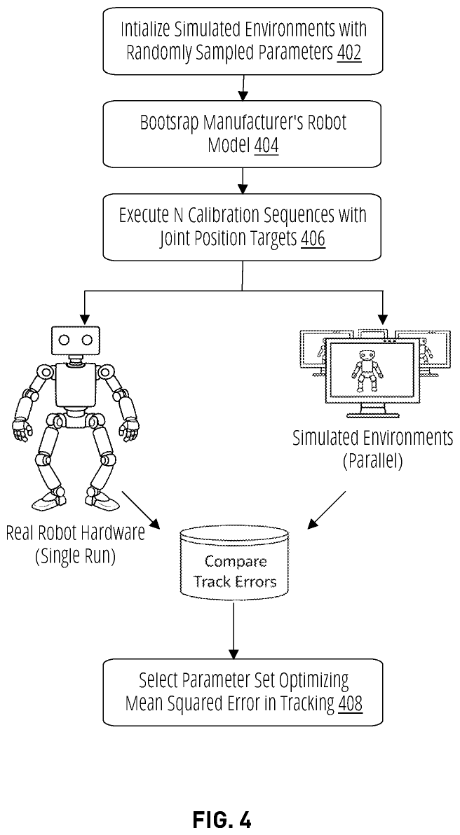

FIG. 4 depicts an embodiment of a process to calibrate a real-to-simulation tuner to a particular physical environment. The calibration process begins by initializing multiple simulated environments using randomly sampled parameter combinations from the parameter space (block 402), bootstrapped from the manufacturer's robot model file (block 404). It then executes N calibration sequences consisting of joint position targets on both the real robot hardware (single run) and the simulated environments in parallel (block 406).

By comparing the tracking error between each simulated environment and the real robot when following the same joint targets, the module selects the parameter set that minimizes the mean squared error in tracking performance (block 408). This approach obviates time- and cost-intensive iterative manual tuning by applying only one set of calibration runs on the robot, automatically optimizing conventionally hard-to-tune URDF parameters, and supporting parallel evaluation of multiple parameter combinations.

The processes' generality enables the tuning of any exposed simulator or robot model parameter that affects kinematic behavior. The modeling of objects in the physical environment as primitive shapes such as cylinders with randomized parameters may be sufficient for the learning of effective sim-to-real transferrable dexterous manipulation policies.

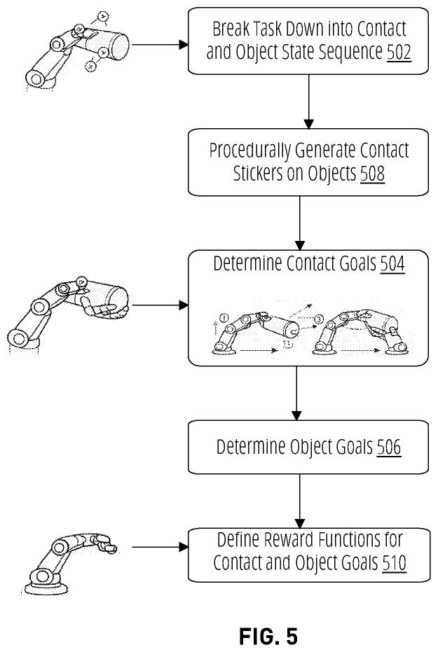

FIG. 5 depicts a process for determining reward functions for robotic learning of manipulation tasks.

Tasks to train a humanoid robot on may be initialized by collecting task-aware play data from humans, for example via input from a teleoperation system for bimanual multi-fingered hands to the simulator of choice. The collected states, including object poses and robot joint positions, may then randomly sampled as task initialization states in simulation. Unlike conventional approaches that requires full demonstration trajectories, with the disclosed mechanisms the teleoperators need not successfully accomplish the task, and need only to “play around” with the task goal in mind while environmental states are collected. The may greatly reduce the time needed for teleoperation, since teleoperators do not need to spend time “ramping up” to collect high-quality data.

Once initialized, each task of interest is broken down into an interleaving sequence of contact states and object states (block 502). For example, the handover task can be broken down into the following steps: (1) one hand contacting the object; (2) object being lifted up to a position near the other hand; (3) the other hand contacting the object; (4) object being transferred to the final goal position.

The reward may then be defined based on solely the “contact goals” and “object goals”: each contact goal may be determined (block 504) by penalizing the distance from fingers to desirable contact points or simply the object's center-of-mass position; each object goal may be determined (block 506) by penalizing the distance from its current state (e.g. current xyz position) to its target state (e.g. target xyz position).

To reduce the difficulty of specifying contact goals, a keypoint-based technique may be applied as follows: for each simulated asset, we procedurally generate a set of “contact stickers” attaching to the surface of object (block 508), where each sticker represents a potentially desirable contact point.

The mechanisms disclosed herein may be implemented in and/or by computing devices utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. Exemplary architectures will now be described that may be configured to implement the mechanisms disclosed herein, for example using a memory/machine-readable media (e.g., memory 602, main memory 1102) comprising instructions that, when executed by one or more graphics processing unit (e.g., parallel processing unit 604), central processing unit (e.g., central processing unit 1002), or other data processors (e.g., general processing cluster 606, data processing cluster 702) to configure the system to implement the disclosed mechanisms.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

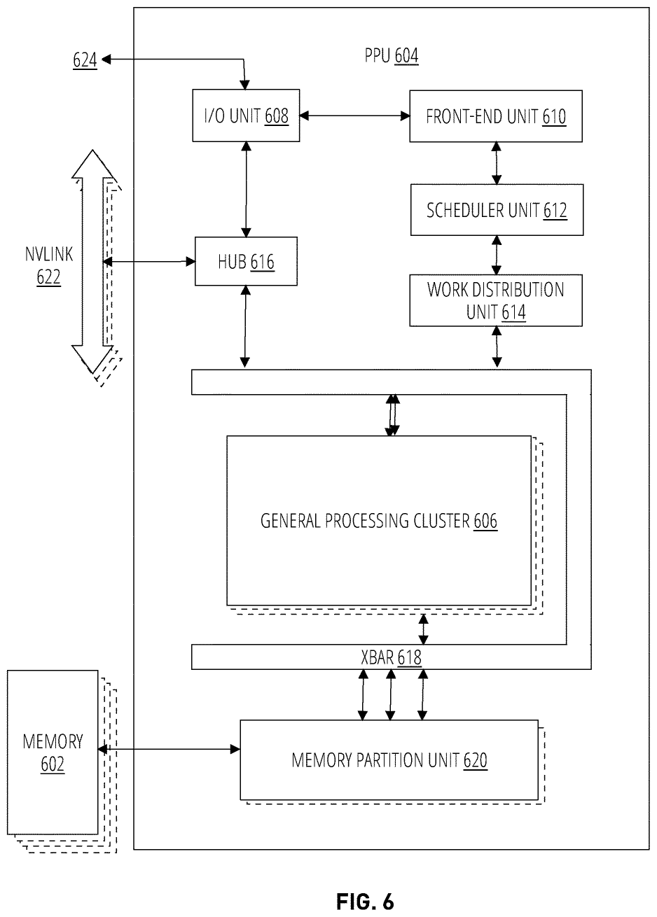

FIG. 6 depicts a parallel processing unit 604, in accordance with an embodiment. In an embodiment, the parallel processing unit 604 is a multi-threaded processor that is implemented on one or more integrated circuit devices. The parallel processing unit 604 is a latency hiding architecture designed to process many threads in parallel. A thread (e.g., a thread of execution) is an instantiation of a set of instructions configured to be executed by the parallel processing unit 604. In an embodiment, the parallel processing unit 604 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 604 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 604 modules may be configured to accelerate thousands of High Performance Computing (HPC), data center, and machine learning applications. The parallel processing unit 604 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 6, the parallel processing unit 604 includes an I/O unit 608, a front-end unit 610, a scheduler unit 612, a work distribution unit 614, a hub 616, a crossbar 618, one or more general processing cluster 606 modules, and one or more memory partition unit 620 modules. The parallel processing unit 604 may be connected to a host processor or other parallel processing unit 604 modules via one or more high-speed NVLink 622 interconnects. The parallel processing unit 604 may be connected to a host processor or other peripheral devices via an interconnect 624. The parallel processing unit 604 may also be connected to a local memory comprising a number of memory 602 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 602 may comprise logic to configure the parallel processing unit 604 to carry out aspects of the techniques disclosed herein.

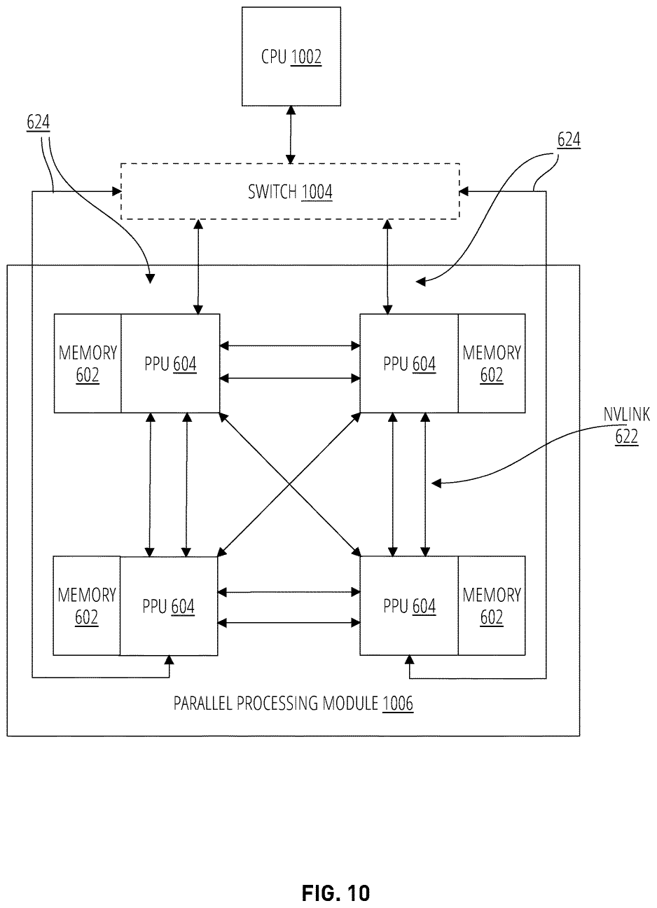

The NVLink 622 interconnect enables systems to scale and include one or more parallel processing unit 604 modules combined with one or more CPUs, supports cache coherence between the parallel processing unit 604 modules and CPUs, and CPU mastering. Data and/or commands may be transmitted by the NVLink 622 through the hub 616 to/from other units of the parallel processing unit 604 such as one or more copy engines, a video encoder, a video decoder, a power management unit, etc. (not explicitly shown). The NVLink 622 is described in more detail in conjunction with FIG. 10.

The I/O unit 608 is configured to transmit and receive communications (e.g., commands, data, etc.) from a host processor (not shown) over the interconnect 624. The I/O unit 608 may communicate with the host processor directly via the interconnect 624 or through one or more intermediate devices such as a memory bridge. In an embodiment, the I/O unit 608 may communicate with one or more other processors, such as one or more parallel processing unit 604 modules via the interconnect 624. In an embodiment, the I/O unit 608 implements a Peripheral Component Interconnect Express (PCIe) interface for communications over a PCIe bus and the interconnect 624 is a PCIe bus. In alternative embodiments, the I/O unit 608 may implement other types of well-known interfaces for communicating with external devices.

The I/O unit 608 decodes packets received via the interconnect 624. In an embodiment, the packets represent commands configured to cause the parallel processing unit 604 to perform various operations. The I/O unit 608 transmits the decoded commands to various other units of the parallel processing unit 604 as the commands may specify. For example, some commands may be transmitted to the front-end unit 610. Other commands may be transmitted to the hub 616 or other units of the parallel processing unit 604 such as one or more copy engines, a video encoder, a video decoder, a power management unit, etc. (not explicitly shown). In other words, the I/O unit 608 is configured to route communications between and among the various logical units of the parallel processing unit 604.

In an embodiment, a program executed by the host processor encodes a command stream in a buffer that provides workloads to the parallel processing unit 604 for processing. A workload may comprise several instructions and data to be processed by those instructions. The buffer is a region in a memory that is accessible (e.g., read/write) by both the host processor and the parallel processing unit 604. For example, the I/O unit 608 may be configured to access the buffer in a system memory connected to the interconnect 624 via memory requests transmitted over the interconnect 624. In an embodiment, the host processor writes the command stream to the buffer and then transmits a pointer to the start of the command stream to the parallel processing unit 604. The front-end unit 610 receives pointers to one or more command streams. The front-end unit 610 manages the one or more streams, reading commands from the streams and forwarding commands to the various units of the parallel processing unit 604.

The front-end unit 610 is coupled to a scheduler unit 612 that configures the various general processing cluster 606 modules to process tasks defined by the one or more streams. The scheduler unit 612 is configured to track state information related to the various tasks managed by the scheduler unit 612. The state may indicate which general processing cluster 606 a task is assigned to, whether the task is active or inactive, a priority level associated with the task, and so forth. The scheduler unit 612 manages the execution of a plurality of tasks on the one or more general processing cluster 606 modules.

The scheduler unit 612 is coupled to a work distribution unit 614 that is configured to dispatch tasks for execution on the general processing cluster 606 modules. The work distribution unit 614 may track a number of scheduled tasks received from the scheduler unit 612. In an embodiment, the work distribution unit 614 manages a pending task pool and an active task pool for each of the general processing cluster 606 modules. The pending task pool may comprise a number of slots (e.g., 32 slots) that contain tasks assigned to be processed by a particular general processing cluster 606. The active task pool may comprise a number of slots (e.g., 4 slots) for tasks that are actively being processed by the general processing cluster 606 modules. As a general processing cluster 606 finishes the execution of a task, that task is evicted from the active task pool for the general processing cluster 606 and one of the other tasks from the pending task pool is selected and scheduled for execution on the general processing cluster 606. If an active task has been idle on the general processing cluster 606, such as while waiting for a data dependency to be resolved, then the active task may be evicted from the general processing cluster 606 and returned to the pending task pool while another task in the pending task pool is selected and scheduled for execution on the general processing cluster 606.

The work distribution unit 614 communicates with the one or more general processing cluster 606 modules via crossbar 618. The crossbar 618 is an interconnect network that couples many of the units of the parallel processing unit 604 to other units of the parallel processing unit 604. For example, the crossbar 618 may be configured to couple the work distribution unit 614 to a particular general processing cluster 606. Although not shown explicitly, one or more other units of the parallel processing unit 604 may also be connected to the crossbar 618 via the hub 616.

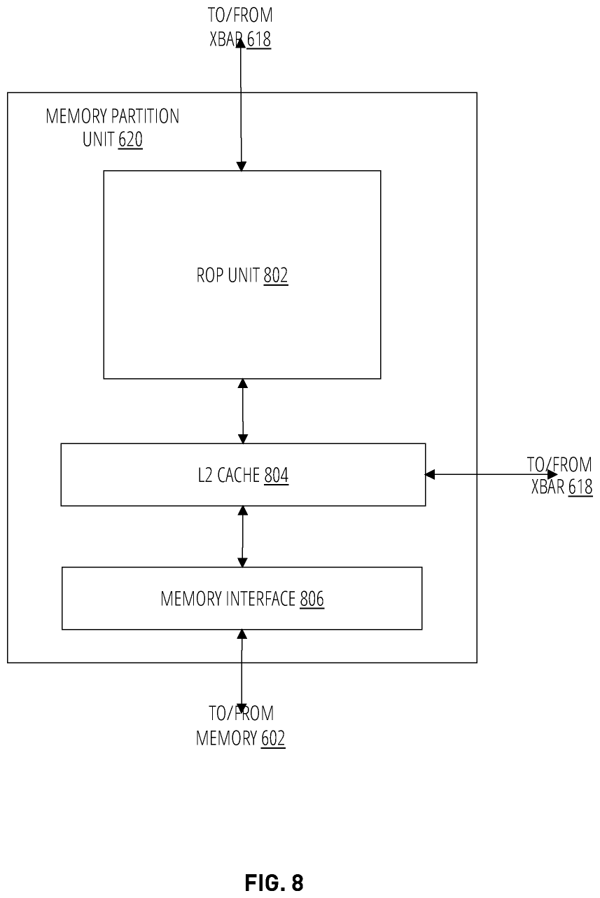

The tasks are managed by the scheduler unit 612 and dispatched to a general processing cluster 606 by the work distribution unit 614. The general processing cluster 606 is configured to process the task and generate results. The results may be consumed by other tasks within the general processing cluster 606, routed to a different general processing cluster 606 via the crossbar 618, or stored in the memory 602. The results can be written to the memory 602 via the memory partition unit 620 modules, which implement a memory interface for reading and writing data to/from the memory 602. The results can be transmitted to another parallel processing unit 604 or CPU via the NVLink 622. In an embodiment, the parallel processing unit 604 includes a number U of memory partition unit 620 modules that is equal to the number of separate and distinct memory 602 devices coupled to the parallel processing unit 604. A memory partition unit 620 will be described in more detail below in conjunction with FIG. 8.

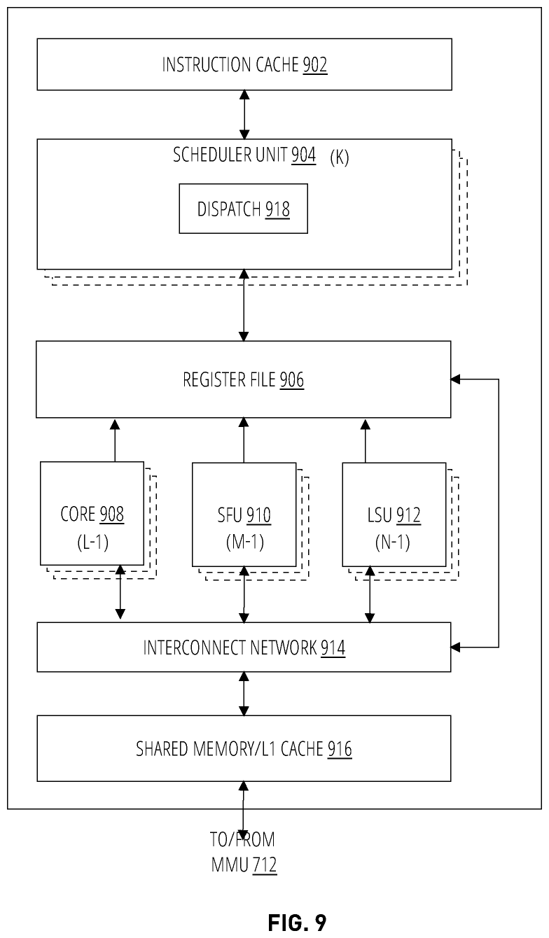

In an embodiment, a host processor executes a driver kernel that implements an application programming interface (API) that enables one or more applications executing on the host processor to schedule operations for execution on the parallel processing unit 604. In an embodiment, multiple compute applications are simultaneously executed by the parallel processing unit 604 and the parallel processing unit 604 provides isolation, quality of service (QOS), and independent address spaces for the multiple compute applications. An application may generate instructions (e.g., API calls) that cause the driver kernel to generate one or more tasks for execution by the parallel processing unit 604. The driver kernel outputs tasks to one or more streams being processed by the parallel processing unit 604. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 9.

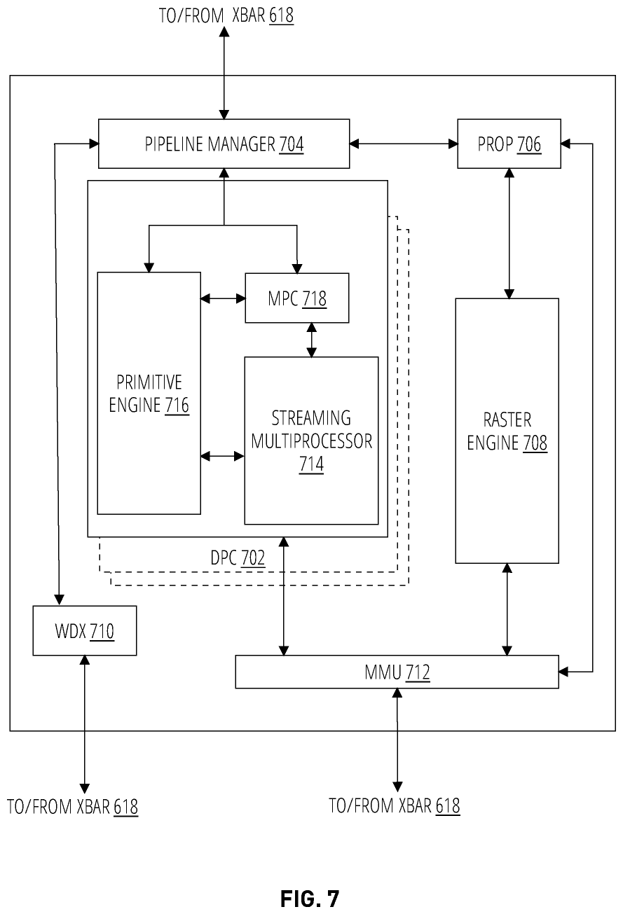

FIG. 7 depicts a general processing cluster 606 of the parallel processing unit 604 of FIG. 6, in accordance with an embodiment. As shown in FIG. 7, each general processing cluster 606 includes a number of hardware units for processing tasks. In an embodiment, each general processing cluster 606 includes a pipeline manager 704, a pre-raster operations unit 706, a raster engine 708, a work distribution crossbar 710, a memory management unit 712, and one or more data processing cluster 702. It will be appreciated that the general processing cluster 606 of FIG. 7 may include other hardware units in lieu of or in addition to the units shown in FIG. 7.

In an embodiment, the operation of the general processing cluster 606 is controlled by the pipeline manager 704. The pipeline manager 704 manages the configuration of the one or more data processing cluster 702 modules for processing tasks allocated to the general processing cluster 606. In an embodiment, the pipeline manager 704 may configure at least one of the one or more data processing cluster 702 modules to implement at least a portion of a graphics rendering pipeline. For example, a data processing cluster 702 may be configured to execute a vertex shader program on the programmable streaming multiprocessor 714. The pipeline manager 704 may also be configured to route packets received from the work distribution unit 614 to the appropriate logical units within the general processing cluster 606. For example, some packets may be routed to fixed function hardware units in the pre-raster operations unit 706 and/or raster engine 708 while other packets may be routed to the data processing cluster 702 modules for processing by the primitive engine 716 or the streaming multiprocessor 714. In an embodiment, the pipeline manager 704 may configure at least one of the one or more data processing cluster 702 modules to implement a neural network model and/or a computing pipeline.

The pre-raster operations unit 706 is configured to route data generated by the raster engine 708 and the data processing cluster 702 modules to a Raster Operations (ROP) unit, described in more detail in conjunction with FIG. 8. The pre-raster operations unit 706 may also be configured to perform optimizations for color blending, organize pixel data, perform address translations, and the like.

The raster engine 708 includes a number of fixed function hardware units configured to perform various raster operations. In an embodiment, the raster engine 708 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 708 comprises fragments to be processed, for example, by a fragment shader implemented within a data processing cluster 702.

Each data processing cluster 702 included in the general processing cluster 606 includes an M-pipe controller 718, a primitive engine 716, and one or more streaming multiprocessor 714 modules. The M-pipe controller 718 controls the operation of the data processing cluster 702, routing packets received from the pipeline manager 704 to the appropriate units in the data processing cluster 702. For example, packets associated with a vertex may be routed to the primitive engine 716, which is configured to fetch vertex attributes associated with the vertex from the memory 602. In contrast, packets associated with a shader program may be transmitted to the streaming multiprocessor 714.

The streaming multiprocessor 714 comprises a programmable streaming processor that is configured to process tasks represented by a number of threads. Each streaming multiprocessor 714 is multi-threaded and configured to execute a plurality of threads (e.g., 32 threads) from a particular group of threads concurrently. In an embodiment, the streaming multiprocessor 714 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 714 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 714 will be described in more detail below in conjunction with FIG. 9.

The memory management unit 712 provides an interface between the general processing cluster 606 and the memory partition unit 620. The memory management unit 712 may provide translation of virtual addresses into physical addresses, memory protection, and arbitration of memory requests. In an embodiment, the memory management unit 712 provides one or more translation lookaside buffers (TLBs) for performing translation of virtual addresses into physical addresses in the memory 602.

FIG. 8 depicts a memory partition unit 620 of the parallel processing unit 604 of FIG. 6, in accordance with an embodiment. As shown in FIG. 8, the memory partition unit 620 includes a raster operations unit 802, a level two cache 804, and a memory interface 806. The memory interface 806 is coupled to the memory 602. Memory interface 806 may implement 32, 64, 128, 1024-bit data buses, or the like, for high-speed data transfer. In an embodiment, the parallel processing unit 604 incorporates U memory interface 806 modules, one memory interface 806 per pair of memory partition unit 620 modules, where each pair of memory partition unit 620 modules is connected to a corresponding memory 602 device. For example, parallel processing unit 604 may be connected to up to Y memory 602 devices, such as high bandwidth memory stacks or graphics double-data-rate, version 5, synchronous dynamic random access memory, or other types of persistent storage.

In an embodiment, the memory interface 806 implements an HBM2 memory interface and Y equals half U. In an embodiment, the HBM2 memory stacks are located on the same physical package as the parallel processing unit 604, providing substantial power and area savings compared with conventionalGDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 602 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 604 modules process very large datasets and/or run applications for extended periods.

In an embodiment, the parallel processing unit 604 implements a multi-level memory hierarchy. In an embodiment, the memory partition unit 620 supports a unified memory to provide a single unified virtual address space for CPU and parallel processing unit 604 memory, enabling data sharing between virtual memory systems. In an embodiment the frequency of accesses by a parallel processing unit 604 to memory located on other processors is traced to ensure that memory pages are moved to the physical memory of the parallel processing unit 604 that is accessing the pages more frequently. In an embodiment, the NVLink 622 supports address translation services allowing the parallel processing unit 604 to directly access a CPU's page tables and providing full access to CPU memory by the parallel processing unit 604.

In an embodiment, copy engines transfer data between multiple parallel processing unit 604 modules or between parallel processing unit 604 modules and CPUs. The copy engines can generate page faults for addresses that are not mapped into the page tables. The memory partition unit 620 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 602 or other system memory may be fetched by the memory partition unit 620 and stored in the level two cache 804, which is located on-chip and is shared between the various general processing cluster 606 modules. As shown, each memory partition unit 620 includes a portion of the level two cache 804 associated with a corresponding memory 602 device. Lower level caches may then be implemented in various units within the general processing cluster 606 modules. For example, each of the streaming multiprocessor 714 modules may implement an L1 cache. The L1 cache is private memory that is dedicated to a particular streaming multiprocessor 714. Data from the level two cache 804 may be fetched and stored in each of the L1 caches for processing in the functional units of the streaming multiprocessor 714 modules. The level two cache 804 is coupled to the memory interface 806 and the crossbar 618.

The raster operations unit 802 performs graphics raster operations related to pixel color, such as color compression, pixel blending, and the like. The raster operations unit 802 also implements depth testing in conjunction with the raster engine 708, receiving a depth for a sample location associated with a pixel fragment from the culling engine of the raster engine 708. The depth is tested against a corresponding depth in a depth buffer for a sample location associated with the fragment. If the fragment passes the depth test for the sample location, then the raster operations unit 802 updates the depth buffer and transmits a result of the depth test to the raster engine 708. It will be appreciated that the number of partition memory partition unit 620 modules may be different than the number of general processing cluster 606 modules and, therefore, each raster operations unit 802 may be coupled to each of the general processing cluster 606 modules. The raster operations unit 802 tracks packets received from the different general processing cluster 606 modules and determines which general processing cluster 1 that a result generated by the raster operations unit 802 is routed to through the crossbar 618. Although the raster operations unit 802 is included within the memory partition unit 620 in FIG. 8, in other embodiment, the raster operations unit 802 may be outside of the memory partition unit 620. For example, the raster operations unit 802 may reside in the general processing cluster 606 or another unit.

FIG. 9 illustrates the streaming multiprocessor 714 of FIG. 7, in accordance with an embodiment. As shown in FIG. 9, the streaming multiprocessor 714 includes an instruction cache 902, one or more scheduler unit 904 modules (e.g., such as scheduler unit 612), a register file 906, one or more processing core 908 modules, one or more special function unit 910 modules, one or more load/store unit 912 modules, an interconnect network 914, and a shared memory/L1 cache 916.

As described above, the work distribution unit 614 dispatches tasks for execution on the general processing cluster 606 modules of the parallel processing unit 604. The tasks are allocated to a particular data processing cluster 702 within a general processing cluster 606 and, if the task is associated with a shader program, the task may be allocated to a streaming multiprocessor 714. The scheduler unit 612 receives the tasks from the work distribution unit 614 and manages instruction scheduling for one or more thread blocks assigned to the streaming multiprocessor 714. The scheduler unit 904 schedules thread blocks for execution as warps of parallel threads, where each thread block is allocated at least one warp. In an embodiment, each warp executes 32 threads. The scheduler unit 904 may manage a plurality of different thread blocks, allocating the warps to the different thread blocks and then dispatching instructions from the plurality of different cooperative groups to the various functional units (e.g., core 908 modules, special function unit 910 modules, and load/store unit 912 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 918 unit is configured within the scheduler unit 904 to transmit instructions to one or more of the functional units. In one embodiment, the scheduler unit 904 includes two dispatch 918 units that enable two different instructions from the same warp to be dispatched during each clock cycle. In alternative embodiments, each scheduler unit 904 may include a single dispatch 918 unit or additional dispatch 918 units.

Each streaming multiprocessor 714 includes a register file 906 that provides a set of registers for the functional units of the streaming multiprocessor 714. In an embodiment, the register file 906 is divided between each of the functional units such that each functional unit is allocated a dedicated portion of the register file 906. In another embodiment, the register file 906 is divided between the different warps being executed by the streaming multiprocessor 714. The register file 906 provides temporary storage for operands connected to the data paths of the functional units.

Each streaming multiprocessor 714 comprises L processing core 908 modules. In an embodiment, the streaming multiprocessor 714 includes a large number (e.g., 128, etc.) of distinct processing core 908 modules. Each core 908 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 908 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 908 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 714 also comprises M special function unit 910 modules that perform special functions (e.g., attribute evaluation, reciprocal square root, and the like). In an embodiment, the special function unit 910 modules may include a tree traversal unit configured to traverse a hierarchical tree data structure. In an embodiment, the special function unit 910 modules may include texture unit configured to perform texture map filtering operations. In an embodiment, the texture units are configured to load texture maps (e.g., a 2D array of texels) from the memory 602 and sample the texture maps to produce sampled texture values for use in shader programs executed by the streaming multiprocessor 714. In an embodiment, the texture maps are stored in the shared memory/L1 cache 916. The texture units implement texture operations such as filtering operations using mip-maps (e.g., texture maps of varying levels of detail). In an embodiment, each streaming multiprocessor 714 includes two texture units.

Each streaming multiprocessor 714 also comprises N load/store unit 912 modules that implement load and store operations between the shared memory/L1 cache 916 and the register file 906. Each streaming multiprocessor 714 includes an interconnect network 914 that connects each of the functional units to the register file 906 and the load/store unit 912 to the register file 906 and shared memory/L1 cache 916. In an embodiment, the interconnect network 914 is a crossbar that can be configured to connect any of the functional units to any of the registers in the register file 906 and connect the load/store unit 912 modules to the register file 906 and memory locations in shared memory/L1 cache 916.

The shared memory/L1 cache 916 is an array of on-chip memory that allows for data storage and communication between the streaming multiprocessor 714 and the primitive engine 716 and between threads in the streaming multiprocessor 714. In an embodiment, the shared memory/L1 cache 916 comprises 128 KB of storage capacity and is in the path from the streaming multiprocessor 714 to the memory partition unit 620. The shared memory/L1 cache 916 can be used to cache reads and writes. One or more of the shared memory/L1 cache 916, level two cache 804, and memory 602 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 916 enables the shared memory/L1 cache 916 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 6, are bypassed, creating a much simpler programming model. In the general purpose parallel computation configuration, the work distribution unit 614 assigns and distributes blocks of threads directly to the data processing cluster 702 modules. The threads in a block execute the same program, using a unique thread ID in the calculation to ensure each thread generates unique results, using the streaming multiprocessor 714 to execute the program and perform calculations, shared memory/L1 cache 916 to communicate between threads, and the load/store unit 912 to read and write global memory through the shared memory/L1 cache 916 and the memory partition unit 620. When configured for general purpose parallel computation, the streaming multiprocessor 714 can also write commands that the scheduler unit 612 can use to launch new work on the data processing cluster 702 modules.

The parallel processing unit 604 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 604 is embodied on a single semiconductor substrate. In another embodiment, the parallel processing unit 604 is included in a system-on-a-chip (SoC) along with one or more other devices such as additional parallel processing unit 604 modules, the memory 602, a reduced instruction set computer (RISC) CPU, a memory management unit (MMU), a digital-to-analog converter (DAC), and the like.

In an embodiment, the parallel processing unit 604 may be included on a graphics card that includes one or more memory devices. The graphics card may be configured to interface with a PCIe slot on a motherboard of a desktop computer. In yet another embodiment, the parallel processing unit 604 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 10 is a conceptual diagram of a processing system implemented using the parallel processing unit 604 of FIG. 6, in accordance with an embodiment. The processing system includes a central processing unit 1002, an switch 1004, and multiple parallel processing unit 604 modules each and respective memory 602 modules. The switch 1004 is depicted with dashed lines, indicating that it is optional in some embodiments.

The NVLink 622 provides high-speed communication links between each of the parallel processing unit 604 modules. Although a particular number of NVLink 622 and interconnect 624 connections are illustrated in FIG. 10, the number of connections to each parallel processing unit 604 and the central processing unit 1002 may vary. The switch 1004 interfaces between the interconnect 624 and the central processing unit 1002. The parallel processing unit 604 modules, memory 602 modules, and NVLink 622 connections may be situated on a single semiconductor platform to form a parallel processing module 1006. In an embodiment, the switch 1004 supports two or more protocols to interface between various different connections and/or links.

In another embodiment (not shown), the NVLink 622 provides one or more high-speed communication links between each of the parallel processing unit modules (parallel processing unit 604, parallel processing unit 604, parallel processing unit 604, and parallel processing unit 604) and the central processing unit 1002 and the switch 1004 (when present) interfaces between the interconnect 624 and each of the parallel processing unit modules. The parallel processing unit modules, memory 602 modules, and interconnect 624 may be situated on a single semiconductor platform to form a parallel processing module 1006. In yet another embodiment (not shown), the interconnect 624 provides one or more communication links between each of the parallel processing unit modules and the central processing unit 1002 and the switch 1004 interfaces between each of the parallel processing unit modules using the NVLink 622 to provide one or more high-speed communication links between the parallel processing unit modules. In another embodiment (not shown), the NVLink 622 provides one or more high-speed communication links between the parallel processing unit modules and the central processing unit 1002 through the switch 1004. In yet another embodiment (not shown), the interconnect 624 provides one or more communication links between each of the parallel processing unit modules directly. One or more of the NVLink 622 high-speed communication links may be implemented as a physical NVLink interconnect or either an on-chip or on-die interconnect using the same protocol as the NVLink 622.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1006 may be implemented as a circuit board substrate and each of the parallel processing unit modules and/or memory 602 modules may be packaged devices. In an embodiment, the central processing unit 1002, switch 1004, and the parallel processing module 1006 are situated on a single semiconductor platform.

In an embodiment, each parallel processing unit module includes six NVLink 622 interfaces (as shown in FIG. 10, five NVLink 622 interfaces are included for each parallel processing unit module). The NVLink 622 may be operated exclusively for PPU-to-PPU communication as shown in FIG. 10, or some combination of PPU-to-PPU and PPU-to-CPU, when the central processing unit 1002 also includes one or more NVLink 622 interfaces.

In an embodiment, the NVLink 622 allows direct load/store/atomic access from the central processing unit 1002 to each parallel processing unit module's memory 602. In an embodiment, the NVLink 622 supports coherency operations, allowing data read from the memory 602 modules to be stored in the cache hierarchy of the central processing unit 1002, reducing cache access latency for the central processing unit 1002. In an embodiment, the NVLink 622 includes support for Address Translation Services (ATS), enabling the parallel processing unit module to directly access page tables within the central processing unit 1002. One or more of the NVLink 622 may also be configured to operate in a low-power mode.

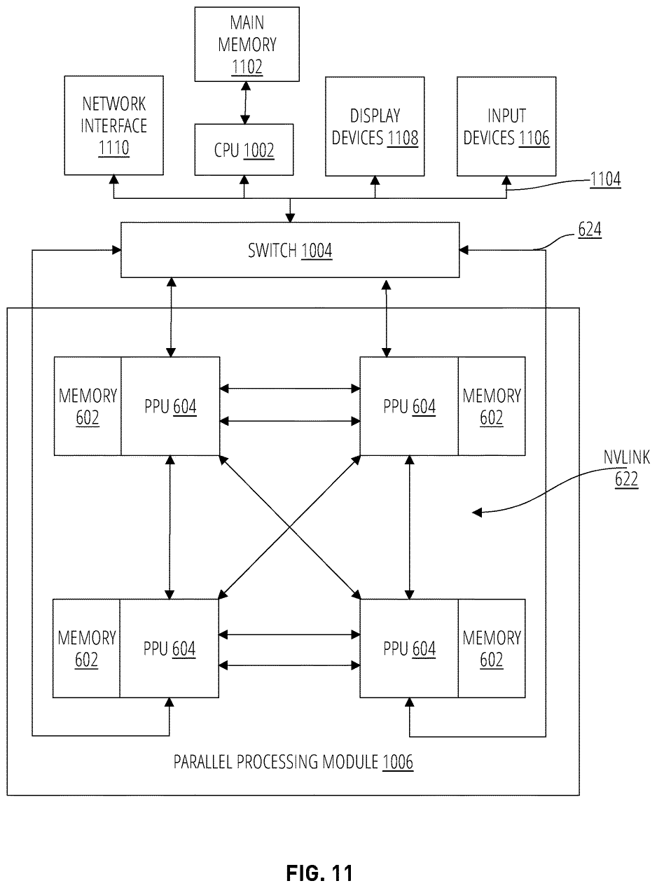

FIG. 11 depicts an exemplary processing system in which the various architecture and/or functionality of the various previous embodiments may be implemented. As shown, an exemplary processing system is provided including at least one central processing unit 1002 that is connected to a communications bus 1104. The communication communications bus 1104 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1102. Control logic (software) and data are stored in the main memory 1102 which may take the form of random access memory (RAM). For simplicity of illustration, the main memory 1102 may be understood to comprise other forms of bulk memory, including non-volatile memory technologies.

The exemplary processing system also includes input devices 1106, the parallel processing module 1006, and display devices 1108, e.g. a conventional CRT (cathode ray tube), LCD (liquid crystal display), LED (light emitting diode), plasma display or the like. User input may be received from the input devices 1106, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1110 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1102 and/or the secondary storage. Such computer programs, when executed, enable the exemplary processing system to perform various functions. The main memory 1102, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

The contact goal, in terms of reward, may be specified as

$${r}_{contact} = {\sum }_{i} [ \frac{1}{1 + α d ( {X}^{L} , {F}_{i}^{L} )} + \frac{1}{1 + β d ( {X}^{R} , {F}_{i}^{R} )} ] \qquad ( 1 )$$

where X^{L}∈ [symbol] and X^{R}∈ [symbol] are the positions of contact markers specified for left and right hands, F^{L}∈ [symbol] and F^{R}∈ [symbol] are the position of left and right fingertips, α and β are scaling hyperparameters, and dis a distance function defined as

$$d ( A , x ) = {min}_{i} {\vert {A}_{i} - x \vert}_{2} .$$

The reward function may be configured into a conventional Proximal Policy Optimization algorithm to train the corresponding task policy. For example:

```
#Initialize policy parameters θ
#Initialize reward function parameters φ
for iteration = 1 to N_iterations:
  # ---- Collect Rollouts ----
  D = { }
  # buffer
  for actor = 1 to N_actors:
        run policy Π_θ in environment for T steps
        store (s_t, a_t, r_t, logΠ_old(a_t|s_t), v_t) in D
  # ---- Compute Returns & Advantages ----
  for each trajectory in D:
        compute returns R_t
        compute advantages A_t using GAE:
          δ_t = r_t + γ V_φ(s_{t + 1}) − V_φ(s_t)
          A_t = GAE(δ_t, γ, λ)
  normalize advantages A_t
  # ---- Update Policy and Value ----
    for epoch = 1 to K_epochs:
      sample minibatch B from D
      # Policy ratio
        r_t(θ) = exp( logΠ_θ(a_t|s_t) − logΠ_old(a_t|s_t) )
      # Clipped surrogate objective
        L_clip = mean(
          min( r_t(θ) * A_t,
            clip(r_t(θ), 1−ε, 1+ε) * A_t )
        )
      # Value loss
        L_value = mean( (V_φ(s_t) − R_t)\hat{ }2 )
      # Optional entropy bonus
        L_entropy = mean( entropy(Π_θ(·|s_t)) )
      # Total objective (maximize)
        L_total = L_clip − c1 * L_value + c2 * L_entropy
      update θ, φ using gradient ascent on L_total
  end for
end for
```

While higher-dimensional representations encode richer information about the object, the larger sim-to-real gap in those data modalities makes the learned policy more difficult to transfer. On the other hand, it is more difficult to learn optimal policies with lower-dimensional object representations because of the limited amount of information. As a practical solution, the disclosed mechanisms may utilize a combination of both types of object representations to balance the trade-offs: use higher-dimensional representations sparsely, and lower-dimensional ones densely.

A wide range of domain randomizations may be configured to ensure reliable sim-to-real transfer. Physical randomization may include the randomization of object friction, mass, and scale. Random forces may be applied to the object under manipulation to simulate the physical effects that are not implemented by the simulator. Nonphysical randomization models the noise in observation (e.g. joint position measurement and detected object positions) and action. An exemplary set of randomization attributes and parameters is depicted in Table I.

TABLE I
Domain Randomization Setup.

| | |
|---|---|
| Object: Mass (kg) | [0.03, 0.1] |
| Object: Friction | [0.5, 1.5] |
| Object: Shape | × [symbol] (0.95, 1.05) |
| Object: Initial Position (cm) | + [symbol] (−0.02, 0.02) |
| Object: Initial z-orientation | + [symbol] (−0.75, 0.75) |
| Hand: Friction | [0.5, 1.5] |
| PD Controller: P Gain | × [symbol] (0.8, 1.1) |
| PD Controller: D Gain | × [symbol] (0.7, 1.2) |
| Random Force: Scale | 2.0 |
| Random Force: Probability | 0.2 |
| Random Force: Decay Coeff. and Interval | 0.99 every 0.1 s |
| Object Pos Observation: Noise | 0.02 |
| Joint Observation Noise. | + [symbol] (0, 0.4) |
| Action Noise. | + [symbol] (0, 0.1) |
| Frame Lag Probability | 0.1 |
| Action Lag Probability | 0.1 |
| Depth: Camera Pos Noise (cm) | 0.005 |
| Depth: Camera Rot Noise (deg) | 5.0 |
| Depth: Camera Field-of-View (deg) | 5.0 |

### LISTING OF DRAWING ELEMENTS

102 physical environment
104 physical object
106 humanoid robot
108 multi-fingered manipulator
110 real-to-simulation tuner
112 simulated environment
202 block
204 block
206 block
208 block
210 block
402 block
404 block
406 block
408 block
502 block
504 block
506 block
508 block
510 block
602 memory
604 parallel processing unit
606 general processing cluster
608 I/O unit
610 front-end unit
612 scheduler unit
614 work distribution unit
616 hub
618 crossbar
620 memory partition unit
622 NVLink
624 interconnect
702 data processing cluster
704 pipeline manager
706 pre-raster operations unit
708 raster engine
710 work distribution crossbar
712 memory management unit
714 streaming multiprocessor
716 primitive engine
718 M-pipe controller
802 raster operations unit
804 level two cache
806 memory interface
902 instruction cache
904 scheduler unit
906 register file
908 core
910 special function unit
912 load/store unit
914 interconnect network
916 shared memory/L1 cache
918 dispatch
1002 central processing unit
1004 switch
1006 parallel processing module
1102 main memory
1104 communications bus
1106 input devices
1108 display devices
1110 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A computer-implemented method for configuring a humanoid robot comprising a plurality of multi-fingered graspers to perform dexterous manipulation tasks, the method comprising:
generating a plurality of simulated environments representing a distribution of kinematic parameter combinations corresponding to a physical robot;
executing, in each simulated environment, a target trajectory sequence recorded from the physical robot;
computing, for each simulated environment, a tracking error relative to execution of the target trajectory sequence by the physical robot;
selecting one or more simulated environments based on a minimization of an average difference between simulated tracking error and real-world tracking error;
training a manipulation policy within the selected simulated environments using reinforcement learning; and
configuring the physical robot with the manipulation policy.

2. The method of claim 1, further comprising defining a generalized reward mechanism partitioning rewards into contact goals and object goals.

3. The method of claim 2, wherein the contact goals are encoded as a keypoint-based representation comprising predefined contact keypoints associated with surfaces of simulated objects.

4. The method of claim 2, wherein the object goals are determined by penalizing a distance between a current object state and a target object state comprising at least one of position, orientation, or pose.

5. The method of claim 1, further comprising decomposing a manipulation task into a plurality of reduced-dimensionality sub-tasks, training expert policies for the sub-tasks, and distilling the expert policies into a generalist policy for execution of a full-horizon task.

6. The method of claim 5, wherein the distillation comprises combining outputs of the expert policies through supervised learning to improve sample efficiency of reinforcement learning exploration.

7. The method of claim 1, wherein training utilizes a mixture of low-dimensional object representations and high-dimensional object representations, the high-dimensional representations augmented with modality-specific settings to reduce a simulation-to-real perception gap.

8. The method of claim 1, wherein task initialization parameters are derived from demonstration data obtained from human execution of the manipulation tasks.

9. A system comprising:
a robot comprising a multi-fingered grasper;
one or more data processors;
a memory comprising instructions that, when executed by the one or more data processors, configure the system to:
generate a plurality of simulated environments representing a distribution of kinematic parameter combinations corresponding to robot;
execute, in each simulated environment, a target trajectory sequence recorded from the robot;
compute, for each simulated environment, a tracking error relative to execution of the target trajectory sequence by the robot;
select one or more simulated environments based on a minimization of an average difference between simulated tracking error and real-world tracking error;
train a manipulation policy within the selected simulated environments using reinforcement learning; and
configure the robot with the manipulation policy.

10. The system of claim 9, wherein the instructions, when executed by the one or more data processors, further configure the system to:
configure a generalized reward mechanism partitioning rewards into contact goals and object goals.

11. The system of claim 10, wherein the contact goals are encoded as a keypoint-based representation comprising predefined contact keypoints associated with surfaces of simulated objects.

12. The system of claim 10, wherein the object goals are determined by penalizing a distance between a current object state and a target object state comprising at least one of position, orientation, or pose.

13. The system of claim 9, wherein the instructions, when executed by the one or more data processors, further configure the system to:
decompose a manipulation task for the robot into a plurality of reduced-dimensionality sub-tasks, training expert policies for the sub-tasks; and
distill the expert policies into a generalist policy for execution of a full-horizon task.

14. The system of claim 13, wherein distillation of the expert policies comprises combining outputs of the expert policies through supervised learning to improve sample efficiency of reinforcement learning exploration.

15. The system of claim 9, wherein the training utilizes a mixture of low-dimensional object representations and high-dimensional object representations, the high-dimensional representations augmented with modality-specific settings to reduce a simulation-to-real perception gap.

16. The system of claim 9, wherein task initialization parameters are derived from demonstration data obtained from human execution of manipulation tasks.

17. A non-volatile machine-readable media comprising instructions that, when executed by one or more data processors or a computer system, configure the computer system to:
generate a plurality of simulated environments representing a distribution of kinematic parameter combinations corresponding to robot;
execute, in each simulated environment, a target trajectory sequence recorded from the robot;
compute, for each simulated environment, a tracking error relative to execution of the target trajectory sequence by the robot;
select one or more simulated environments based on a minimization of an average difference between simulated tracking error and real-world tracking error;
train a manipulation policy within the selected simulated environments using reinforcement learning.

18. The machine-readable media of claim 17, wherein the instructions, when executed by the one or more data processors, further configure the computer system to:
configure a generalized reward mechanism partitioning rewards into contact goals and object goals.

19. The machine-readable media of claim 17, wherein the instructions, when executed by the one or more data processors, further configure the computer system to:
decompose a manipulation task for the robot into a plurality of reduced-dimensionality sub-tasks, training expert policies for the sub-tasks; and
distill the expert policies into a generalist policy for execution of a full-horizon task.

20. The system of claim 19, wherein distillation of the expert policies comprises combining outputs of the expert policies through supervised learning to improve sample efficiency of reinforcement learning exploration.
